(19) United States
(12) Patent Application Publication
(10) Pub. No.: US 2003/0214692 A1
(43) Pub. Date: Nov. 20, 2003

(54) Print image rotation systems and methods

(76) Inventor: John F. Carver, Palm City, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/407,898

(22) Filed: Apr. 7, 2003

Related U.S. Application Data
(60) Provisional application No. 60/369,840, filed on Apr. 5, 2002.

(51) Int. Cl. G02B 26/08

(52) U.S. Cl. 359/198

(57) ABSTRACT

A print image rotation system. In one embodiment, an image sensor is selectively rotated relative to a fingerprint image such that the fingerprint image is incident upon the image sensor at a preferred orientation. In another embodiment, an optical image rotating component such as a dove prism or a Pechan prism is used to selectively rotate a fingerprint image.

### CROSS-REFERENCE TO RELATED APPLICATIONS

This application claims priority to U.S. Provisional Application No. 60/369,840, filed Apr. 5, 2002, entitled “Fingerprint Image Rotation Systems and Methods,” incorporated herein by reference in its entirety.

### BACKGROUND OF THE INVENTION

1. Field of the Invention

The present invention relates to print scanning.

2. Background Art

Conventional print scanners use light to detect an image of a print. Print scanners that are used to detect a print on a live object (such as, a finger, palm, hand, or foot) are also called live scanners. For example, an object having a print such as one or more fingers can be placed on a platen of a live scanner. An illumination source illuminates the underside of the platen. An image representative of the ridge pattern of the print at the platen is projected by an optical system to an image sensor for detection.

Typically, extract and match software is utilized to analyze print images obtained by print scanners. It is generally preferred that images presented to this type of software are in a particular orientation. Often a vertical orientation is desired. In a vertical orientation, a longitudinal axis of a print is aligned with a vertical axis of an image sensor (and ultimately, a vertical axis of a display or printout, such as, a tenprint format card). In some cases, a vertical orientation assures optimum performance of an extract and match algorithm in terms of extract and match speed and accuracy. Also, users of extract and match software and live scanners are familiar with a vertical orientation.

Problems arise in obtaining a vertical orientation in a live scanner. The orientation of a captured print image relative to an image sensor can vary depending upon a number of factors, including the mounting of the image sensor relative to the optical projection system and the placement of the print on the platen. Properly aligning a biometric object on a platen is difficult. Finger guides have been used above platens to help fix the orientation of finger(s) during a live scan. Specially trained individuals are sometimes required to ensure a finger is positioned at a given orientation with respect to a platen surface. Also, in cases where a finger is required to be vertical on a platen to capture a vertical image at an image sensor, then a platen surface must be sufficiently large to accommodate the length of a finger which increases cost. Captured images that are not in a preferred orientation can be rotated using software routines; however, the quality of such images can be degraded.

### BRIEF SUMMARY OF THE INVENTION

The invention allows print images to be reoriented relative to the image sensor. A print image is rotated relative to an image sensor until the image is in a desired orientation. This rotation can be carried out under automated or manual control. Mechanical and optical techniques for obtaining a preferred orientation of a print image relative to an image sensor are provided.

In one embodiment, an image sensor is selectively rotated relative to a fingerprint image such that the fingerprint image is incident upon the image sensor at a preferred orientation. In another embodiment, an optical image rotating component, such as, a dove prism, is used to selectively rotate a fingerprint image relative to an image sensor.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention. In the drawings:

FIG. 1 is a diagram that shows a fingerprint image rotation system that rotates an image sensor according to one embodiment of the present invention.

FIG. 2 is a diagram that shows a fingerprint image rotation system that rotates an optical component according to an embodiment of the present invention.

FIG. 3 is a flowchart diagram illustrating operation of a control system according to an embodiment of the present invention.

FIG. 4 is a diagram showing an example of a print image oriented relative to an entire frame detected by an image sensor.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

The terms “print scanner” or “live scanner” are used interchangeably herein to refer to any type of scanner that can detect an image of a print. The term “live scan” refers to a scan of any type of print. A live scan can include, but is not limited to, a scan of any biometric object having a print pattern. A print pattern includes one or more ridges and/or valleys associated with the biometric object. The biometric object can include, but is not limited to, a hand, foot, palm, finger, thumb, or toe. As used herein, a live scan can include a scan all or part of one or more biometric objects. Live scans can also capture different types of prints, including, but not limited to, a roll print, flat print, and/or slap print as is well-known in the print scanning art.

To carry out a live scan, a biometric object having a print is placed on a platen of a print scanner. The platen can be stationary or movable. The platen is illuminated by an illumination source. Light is totally internally reflected at the platen depending upon whether a ridge or valley of the print is present. An optical system is provided along an optical path between the plater and an image sensor. In this way, an image of the print on the platen can be captured by an image sensor.

In many live scanners, a prism is placed between the illumination source and the image sensor. Light from the illumination source enters one face of the prism and illuminates the platen. The platen can be a second surface of the prism or an elements in optical contact with the second surface of the prism such that light can be totally internally reflected at the platen depending upon whether a ridge or valley of the print is present reflected. The reflected light then passes from a third face of the prism through an optical projection system along an optical path to an image sensor. See, e.g, the lens system used in the fingerprint detection system described in U.S. Pat. No. 5,900,993, issued to Ellis Betensky (incorporated in its entirety herein by reference).

1. Mechanical Alignment Scheme

According to one aspect of the present invention, an image sensor element of a digital camera is mounted on a rotary actuator mechanism whose angular position can be controlled manually or by a closed loop control system. The center of the image sensor element is positioned so that it is aligned with the center of rotation of the rotary actuator.

Print images projected through an optical system in a print scanner are focused on the image sensor. These images are transmitted to the actuator control system where they are processed to determine the orientation of the print image relative to the image sensor. Both the magnitude of the angle and direction values are determined. From this information, the control system generates the appropriate control signals required to rotate the image sensor in a way that will align the print images with the sensor in a desired orientation.

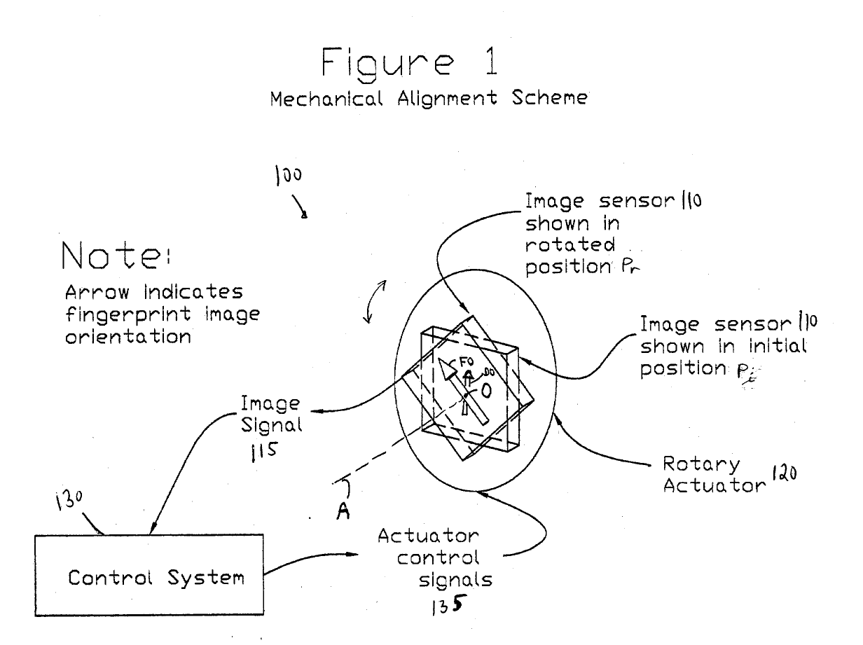

FIG. 1 shows a fingerprint image rotation system 100 according to one embodiment of the present invention. Fingerprint image rotation system 100 includes an image sensor 110 coupled to move with rotary actuator 120. Image sensor 110 can be a sensor element in any type of solid-state camera, including but not limited to, a digital camera, CCD-type camera, or CMOS-type camera. Rotary actuator 120 is rotatable in either direction about an axis A. Preferably, axis A is parallel to or coincides with the optical axis of the optical projection system that projects a print image onto a center O of image sensor 110.

In one embodiment, fingerprint image rotation system 100 includes a control system 130. Control system 130 receives an image signal 115 output from image sensor 110. Image signal 115 can include, but is not limited to, grey-scale or binary data representative of a captured print. Control system 130 then determines a deviation of the captured print from a desired orientation and generates actuator control signal(s) 135. Actuator control signal(s) 135 then drive rotary actuator 120 to rotate about axis A to reduce or eliminate the deviation of the captured print from the desired orientation. In this way, image sensor 110 can be automatically rotated so that print images are captured at a desired orientation relative to the image sensor.

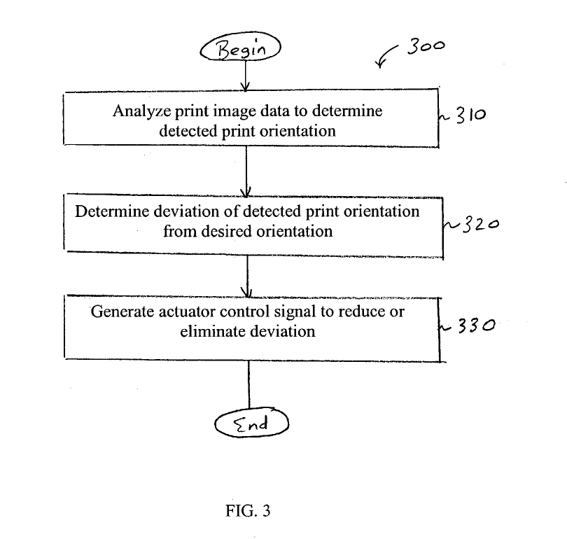

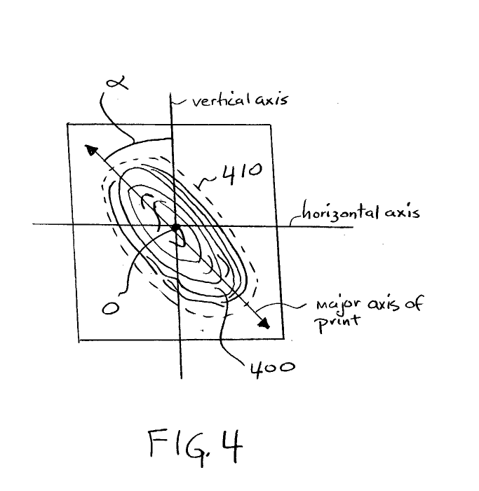

As shown in FIG. 1, a fingerprint orientation (FO) of a captured finger print image is deviated from a desired orientation (DO) with respect to image sensor 110 at an initial position Pᵢ. Control system 130 determines a deviation of the captured print from a desired orientation and generates actuator control signal(s) 135. Actuator control signal(s) 135 then drive rotary actuator 120 to rotate about axis A so that image sensor 110 is automatically rotated to a rotated position Pᵣ so that print images projected to the image sensor at a fingerprint orientation (FO) are captured at a desired orientation (DO) relative to the image sensor 110. Control system 130 is described further below with respect to FIGS. 3 and 4.

Alternatively, image sensor 110 can be manually rotated. In this mode of operation, rotary actuator 120 moves in response to a user control to rotate image sensor 110 while observing images from the sensor until the desired orientation of the image relative to the sensor was obtained.

2. Optical Alignment Scheme

According to another aspect of the present invention, the image sensor element of a digital camera is mounted in a fixed position so that fingerprint images projected from the optical system of a typical fingerprint scanner system fall upon the sensor. A dove prism is positioned so that its longitudinal axis is aligned with the optical axis of the fingerprint scanner system. The dove prism is mounted in a rotary actuator subsystem which is capable or rotating the dove prism about its longitudinal axis. The optical center of the image sensor is located at the center of rotation of the dove prism. Fingerprint images pass through the dove prism and are focused upon the image sensor. Rotation of the dove prism causes the images formed at the image sensor to rotate about the longitudinal axis. A Pechan prism can be used in place of the dove prism.

Fingerprint images from the digital camera are processed by the control system where angle magnitude and direction values are determined. The control system generates the appropriate signals required to rotate the dove prism in a way that will align the fingerprint images with the sensor in a desired orientation.

Alternatively, the dove prism could be manually rotated. In this mode of operation, one would rotate the prism while observing images from the sensor until the desired orientation of the image relative to the sensor was obtained.

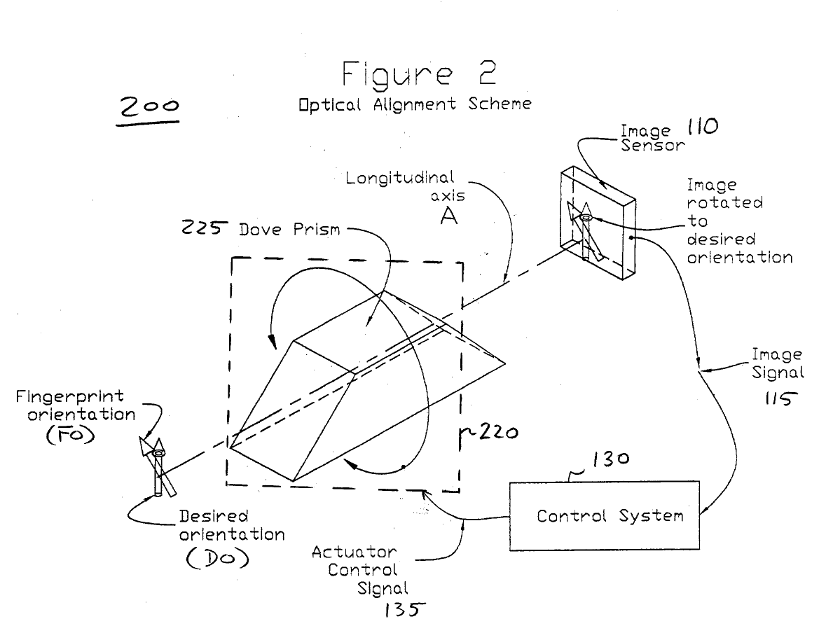

FIG. 2 shows a fingerprint image rotation system 200 that rotates an optical component (e.g., dove prism 225 or a Pechan prism) according to an embodiment of the present invention. As described with respect to FIG. 1, control system 130 receives an image signal 115 output from image sensor 110. Image signal 115 can include, but is not limited to, grey-scale or binary data representative of a captured print. Control system 130 then determines a deviation of the captured print from a desired orientation and generates actuator control signal(s) 135. A rotary actuator 220 holds dove prism 225. Any type of housing or mounting can be used for rotatably supporting dove prism 225 to rotate about axis A to reduce or eliminate the deviation of the captured print from the desired orientation. In this way, dove prism 225 can be automatically rotated so that print images are captured at a desired orientation relative to image sensor 110.

As shown in FIG. 2, a fingerprint orientation (FO) of a captured finger print image is deviated from a desired orientation (DO) with respect to image sensor 110 when dove prism 225 is at an initial position. Control system 130 determines a deviation of the captured print from a desired orientation and generates actuator control signal(s) 135. Actuator control signal(s) 135 then drive the rotary actuator 220 holding dove prism 225 so that dove prism 225 is automatically rotated about axis A to a rotated position so that print images received at a fingerprint orientation (FO) are rotated and passed to image sensor 110 at a desired orientation (DO) relative to the image sensor 110.

Alternatively, dove prism 225 can be manually rotated. In this mode of operation, rotary actuator 220 holding dove prism 225 moves in response to a user control to rotate dove prism 225 while observing images from image sensor 110 until the desired orientation of the image relative to image sensor 110 was obtained.

Alternatively, a Pechan prism can be used instead of dove prism 225. Like the dove prism, rotation of the Pechan prism causes the images formed at the image sensor to rotate about axis A. Both the dove prism and a Pechan prism can be provided along an optical path between a platen and an image sensor in a live scanner as would be apparent to a person skilled in the art given this description. The dove prism is preferably placed at a location where rays are traveling approximately parallel to the longitudinal axis of the dove prism.

In addition, while only one optical channel between a platen and image sensor are described, the present invention (both print image rotation systems 100 and 200) can also be used in dual channel systems having two optical paths and two image sensors, as described for example in U.S. patent application Ser. No. 10/345,420, filed Jan. 16, 2003, incorporated herein by reference in its entirety.

3. Control System

Control system 130 (as used in systems 100 and/or 200) is described further with respect to FIGS. 3 and 4. FIG. 3 is a flowchart diagram illustrating a routine 300 carried out by control system 130 according to an embodiment of the present invention. Control system 130 (including routine 300 and its constituent steps 310-330) can be implemented in software, firmware, hardware or any combination thereof.

Control system 130 receives an image signal 115 output from image sensor 110 and stores image data associated with the image signal 115. For instance, the stored print image data can include, but is not limited to, grey-scale print image data or binary (hi-lo) print data (obtained by first filtering the grey-scale data) representative of a captured print. In step 310, control system 130 analyzes the stored print image data to determine a detected print orientation. For example, as shown in FIG. 4, the print image 400 usually occupies a portion of a frame detected by an image sensor 110. Control system 130 can then analyze the stored print image data and determine a boundary 410 that encompasses the print image 400. Control system 130 then analyzes the shape of the boundary to determine a detected print orientation. For example, the shape of boundary 410 can be used to determine a major axis of the detected print as shown in FIG. 4.

In step 320, control system 310 determines a deviation of the captured print from a desired orientation. For example, if the desired orientation is a vertical axis of the image sensor, then an angle a between the major axis determined in step 310 and the vertical axis can be determined as shown in FIG. 4. In step 330, control system 130 generates actuator control signal(s) 135. Actuator control signal(s) 135 then drives rotary actuator 120 or 220 to rotate about axis A to reduce or eliminate the deviation of the captured print from the desired orientation. For example, where the angle α is calculated in step 320, rotary actuator 120 or 220 are rotated about axis A to reduce angle α to at or near zero.

Conclusion

The present invention can be used in any type of print scanner, including but not limited to, any type of handprint, fingerprint, footprint, and/or palm print scanner. Any type of platen and fingerprint, footprint, and/or palm print scanner can be used. In this way, images are obtained for prints, including prints of all or part of finger(s) and/or palm(s).

While specific embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A print scanner, comprising:
an image sensor that detects an image of a print having an initial print orientation; and
a rotary actuator coupled to said image sensor for rotating said image sensor about an axis to reduce a deviation between the initial print orientation and a desired print orientation relative to said image sensor.

2. The print scanner of claim 1, further comprising:
a control system that generates an actuator control signal for driving said rotary actuator.

3. The print scanner of claim 2, wherein said control system analyzes detected print image data to determine the initial print orientation, determines a deviation of the initial print orientation from the desired print orientation, and generates said actuator control signal such that said rotary actuator rotates said image sensor to reduce or eliminate the determined deviation.

4. The print scanner of claim 1, wherein said rotary actuator rotates in response to manual control.

5. The print scanner of claim 1, wherein said print includes a pattern having one or more ridges or valleys associated with a biometric object.

6. The print scanner of claim 5, wherein said biometric object is an object selected from the following group: a hand, foot, palm, finger, thumb, and toe.

7. A print scanner, comprising:
an image sensor that detects an image of a print having an initial print orientation;
an optical component; and
a rotary actuator coupled to said optical component for rotating said optical component about an axis to reduce a deviation between the initial print orientation and a desired print orientation relative to said image sensor.

8. The print scanner of claim 7, further comprising:
a control system that generates an actuator control signal for driving said rotary actuator.

9. The print scanner of claim 7, wherein said control system analyzes detected print image data to determine the initial print orientation, determines a deviation of the initial print orientation from the desired print orientation, and generates said actuator control signal such that said rotary actuator rotates said optical component relative to said image sensor to reduce or eliminate the determined deviation.

10. The print scanner of claim 7, wherein said rotary actuator rotates in response to manual control.

11. The print scanner of claim 7, wherein said print includes a pattern having one or more ridges or valleys associated with a biometric object.

12. The print scanner of claim 11, wherein said biometric object is an object selected from the following group: a hand, foot, palm, finger, thumb, and toe.

13. The print scanner of claim 7, wherein said optical component comprises a dove prism.

14. The print scanner of claim 7, wherein said optical component comprises a Pechan prism.
